(19) United States
(12) Patent Application Publication
(10) Pub. No.: US 2025/0102731 A1
(43) Pub. Date: Mar. 27, 2025

(54) OPTICAL FIBERS COMPRISING TRIANGULAR TRENCH PROFILE

(71) Applicant: OFS Fitel, LLC, Norcross, GA (US)

(72) Inventors: David D Braganza, Roswell, GA (US); Alan A Klein, Duluth, GA (US); David W Peckham, Lawrenceville, GA (US)

(73) Assignee: OFS Fitel, LLC, Norcross, GA (US)

(21) Appl. No.: 18/291,270

(22) PCT Filed: Jul. 26, 2021
(86) PCT No.: PCT/US21/43225

§ 371 Date: Jan. 23, 2024

(51) Int. Cl. G02B 6/036; G02B 6/028

(52) U.S. Cl. CPC G02B 6/03627; G02B 6/0285

(57) ABSTRACT

An optical fiber that complies with ITU-T G.657.A2 recommendations. The optical fiber comprises an inner cladding that is adjacent to the core, thereby extending from a core radius (r_{core}) to an inner cladding radius (r_{inner_clad}). The inner cladding refractive index decreases approximately linearly as a function of radius (r), thereby decreasing approximately linearly from a first inner cladding relative refractive index (Δ_{inner_clad_1}) to a second inner cladding relative refractive index (Δ_{inner_clad_2}). The ratio of r_{inner_clad} to r_{core} is between approximately 3.2 and approximately 4.2 (˜3.2≤r_{inner_clad}/r_{core}≤˜4.2).

### BACKGROUND

### Field of the Disclosure

The present disclosure relates generally to optical fibers and, more particularly, to single-mode optical fibers.

### Description of Related Art

The International Telecommunication Union (ITU) is a standards-setting organization that publishes recommendations that are, for all practical purposes, accepted as standards for various industries. The Telecommunication Standardization Sector of the ITU (ITU-T) publishes standards for transmission systems and media, digital systems, and networks, which it designates as Series G. Of these, ITU-T G.657 has been widely accepted as the standard for transmission media and optical systems characteristics for optical fiber cables. ITU-T G.657 sets forth detailed performance characteristics of a bending-loss insensitive single-mode optical fiber and cable (available at https://www.itu.int/rec/T-REC-G.657/en and incorporated by reference in its entirety as if expressly set forth herein), with subcategories ITU-T G.657.A1 and ITU-T G.657.A2 providing recommendations for fibers with a minimum macro-bend design radius of ten millimeters (10 mm) and 7.5 mm, respectively. Insofar as those having skill in the art fully understand the ITU-T G.657 standards, only a truncated discussion of the ITU-T G.657 standard is provided herein.

Various optical fiber profiles exist, which accommodate the bend-insensitivity requirements under the ITU-T standards, and there are ongoing efforts to improve optical fiber performance and manufacturing processes for optical fibers that meet, or exceed, the ITU-T G.657 standards.

### SUMMARY

The present disclosure teaches an optical fiber that complies with the ITU-T G.657.A2 standards. The disclosed optical fiber comprises an inner cladding that is adjacent to the core, thereby extending from a core radius (r_{core}) to an inner cladding radius (r_{inner_clad}). The inner cladding refractive index decreases approximately linearly as a function of radius (r), thereby decreasing approximately linearly from a first inner cladding relative refractive index (Δ_{inner_clad_1}) to a second inner cladding relative refractive index (Δ_{inner_clad_2}). To be clear, Δ_{inner_clad_1} represents an inner part of the relative refractive index (i.e., the part that is closer to the core), while Δ_{inner_clad_2} represents an outer part of the relative refractive index (i.e., the part that is closer to the outer cladding). The ratio of r_{inner_clad} to r_{core} is between approximately 3.2 and approximately 4.2 (˜3.2≤r_{inner_clad}/r_{core}≤˜4.2). Preferably, r_{inner_clad}/r_{core}≤˜4.0.

The present disclosure also provides processes for manufacturing the disclosed optical fibers. For other embodiments, the present disclosure further teaches cables comprising the disclosed optical fiber, along with processes for manufacturing such cables.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a drawing that shows a refractive index profile for one embodiment of a commercially available depressed-cladding optical fiber that complies with the ITU-T G.657.A2 recommendations.

FIG. 2 is a drawing that shows refractive index profiles for other embodiments of commercially available optical fibers that comply with the ITU-T G.657.A2 recommendations.

FIG. 3 is a drawing that shows both a triangular trench profile and a refractive index profile for an optical fiber with a trapezoidal trench (trapezoidal trench profile), both of which have macro-bending losses that comply with the ITU-T G.657.A2 recommendations.

FIG. 4 is a table that shows one embodiment of numerical index-profile parameters for the profiles of FIG. 3.

FIG. 5 is a drawing that shows a refractive index profile for one embodiment of an optical fiber with a triangular trench (triangular trench profile) in comparison to the index profiles for other commercially available optical fibers, with the triangular trench profile having macro-bending losses that comply with the ITU-T G.657.A2 recommendations.

FIG. 6A is a table that shows bend-performance parameters for several embodiments of optical fibers having a triangular trench profile.

FIG. 6B is a table that shows bend-performance parameters for several other embodiments of optical fibers having a triangular trench profile.

FIG. 6C is a table that shows bend-performance parameters for several other embodiments of optical fibers having a triangular trench profile.

FIG. 6D is a table that shows bend-performance parameters for several other embodiments of optical fibers having a triangular trench profile.

FIG. 6E is a table that shows bend-performance parameters for several other embodiments of optical fibers having a triangular trench profile.

### DETAILED DESCRIPTION OF THE EMBODIMENTS

Initially, unless indicated otherwise, either expressly or by implied context, it should be noted that all terms (e.g., fiber, cable, core, inner cladding, outer cladding, refractive indices (e.g., n₁, n₂, n₃, etc.), relative refractive index difference (delta or Δ, typically represented in units of percent (%)), trench, dope (or dopant or doping), index profile, profile parameter (alpha or α), overclad, soot, macro-bend (MB), nominal mode-field diameter (MFD, typically represented in units of micrometers (μm)), cutoff, loss, sensitivity, shoulder, etc.) in the specification (including the claims) are used according to their plain and customary meanings as those terms would be understood by those having ordinary skill in the art. Furthermore, for purposes of clarity, unless expressly indicated otherwise or implied by context, the term approximately is expressly defined herein to mean within one significant figure (e.g., approximately 10 means 10±1; approximately 100 means 100±10; and so on).

Turning now to optical fiber designs, ITU-T G.657 has been widely accepted as the standard for transmission media and optical systems characteristics for optical fiber cables. Generally, to meet these standards, either a depressed-cladding (DC) design or a trench-assisted (TA) design is used.

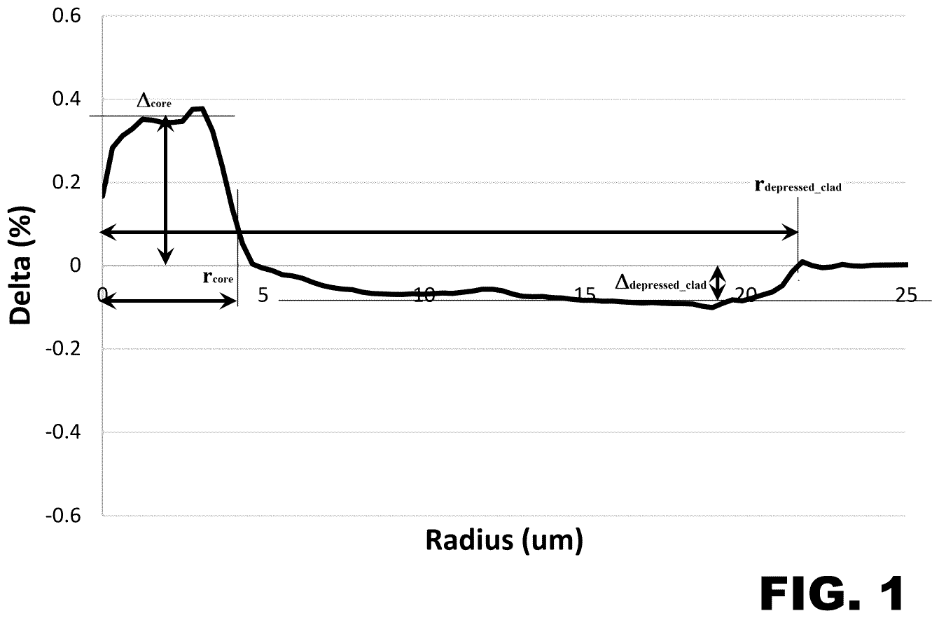

For example, a DC design has a refractive index profile that is similar to that shown in FIG. 1. Specifically, in the embodiment shown in FIG. 1, the index profile comprises a central Germanium (Ge) doped core with a radius of r_{core} and a relative refractive index of Δ_{core}. Radially surrounding the core is a Fluorine (F) doped depressed cladding (possibly with some low concentration of GeO₂ that results from diffusion outward from the core). Radially surrounding the depressed cladding and extending to the fiber radius (typically to approximately 62.5 micrometers (μm)) is an outer cladding that has a reference relative refractive index (Δ₀≅0). The outer cladding is either undoped or lightly doped with F or Chlorine (Cl).

The depressed cladding has a relative refractive index of Δ_{depressed_clad} and extends to a radius of r_{depressed_clad}. In order to comply with the ITU-T G.657.A2 requirements, r_{depressed_clad}/r_{core} is greater than five (r_{depressed_clad}/r_{core}>5) and Δ_{depressed_clad} falls within a range that is between negative 0.02 percent (−0.02%) and −0.12%. These DC fiber properties require fabrication of a core rod that is much larger than an optimum value for balancing attenuation performance and low-cost, high-volume core rod manufacturing. Alternatively, these DC fiber properties require fabrication of the DC region using two (2) separate fabrication steps. Either of these approaches results in additional fabrication costs.

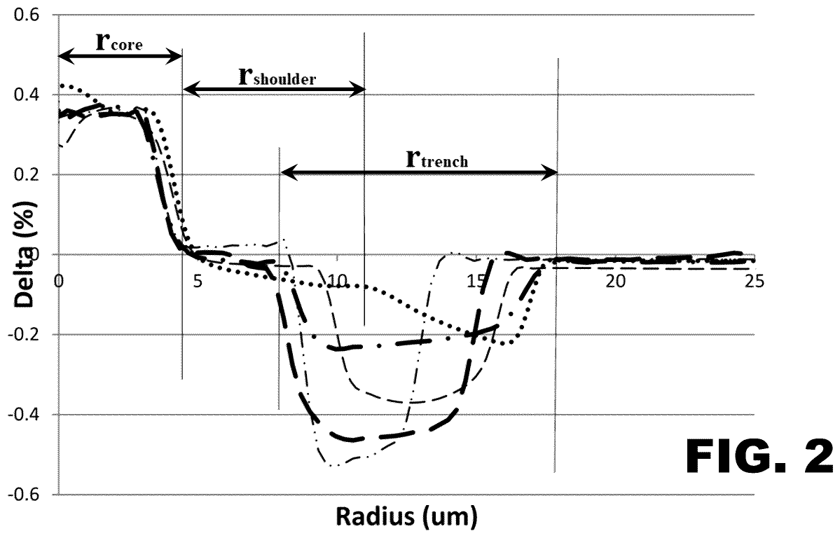

For optical fibers with TA designs, for which an example refractive index profile is shown in FIG. 2, a central Ge-doped core (with a core radius of r_{core}) is surrounded by a lightly doped shoulder (Δ_{shoulder}≅±0.025%), which extends to a radius of r_{shoulder}, which is somewhere between approximately 1.5*r_{core} (˜1.5*r_{core}) and ˜2.5*r_{core}. Radially surrounding the shoulder is a F-doped trench that extends from r_{shoulder} to r_{trench}, with r_{trench}/r_{core} being between ˜2.0 and ˜4.5. An outer cladding extends from r_{trench} to the fiber radius (typically, ˜62.5 μm).

To comply with the ITU-T G.657.A2 standards, the F-doped trench is heavily doped to provide a large delta (typically, Δ_{trench}≅−0.1%), which adds complexity to the preform fabrication process. If a porous soot body is F-doped either during the soot deposition step or the soot dehydration (DH) or sintering steps using a F-containing gas, then the doping is largely dependent on the gas phase diffusion of the F-source (e.g., silicon tetrafluoride (SiF₄)) through the porous body. For example, if F-containing gas is introduced into the DH or sintering atmosphere so that the gas diffuses inward from the outside of the soot body, then there is a tradeoff between F-doping concentrations in the sintered glass body (which adversely affects the trench depth) and the penetration depth of the F. Consequently, the radial variation of the F concentration and radial thickness of the F-doped region is dependent on a complicated function of soot body characteristics (e.g., porosity, density, particle size, etc.) and process conditions (e.g., DH temperature, sintering temperature, atmosphere, speed, etc.). Therefore, it is difficult to correctly fabricate a deep, narrow, radially uniform trench that is isolated to distinct, narrow, specifically designated narrow bands within the core rod soot boules.

If, alternatively, the F-doping is done by introducing the F-source into an oxidizing flame during soot-deposition processing, then the time scale of the deposition processing (relative to the speed of the gas-phase diffusion through the porous soot) results in difficulty in localizing the F-doping within a particular radially distinct region of the soot body. Oftentimes, this difficulty manifests itself as F-doped regions in the soot body where it is undesirable to have F (such as, for example, in the core or shoulder).

The current state-of-the-art processes for fabricating TA optical fibers is to separately: (a) fabricate a sintered rod with both the core and the shoulder; and, thereafter (b) fabricate the heavily F-doped trench by either: (1) depositing a soot layer on the sintered rod, with F-doping occurring during the deposition, DH, or sintering of the soot; or (2) over-jacketing the sintered rod with a heavily F-doped over-cladding jacket using known rod-in-tube processes. Although the separate fabrication of the core+shoulder and the F-doped trench provides better control (as compared to the F-doping of the silica soot boule), this two-step process requires approximately double the processing time and a corresponding increase in manufacturing costs.

In addition to additional manufacturing costs and extended processing time, the two-step process introduces a new glass interface between the shoulder and the trench, which requires careful etching or cleaning of the core-shoulder rod surface. Otherwise, the mechanical integrity of the resulting optical fiber is compromised, or contaminants are introduced at the interface, thereby potentially degrading signal propagation.

To mitigate for these and other deficiencies in DC and TA optical fibers, the present disclosure teaches a triangular or trapezoidal trench (TT) design. The disclosed TT designs have macro-bending losses that comply with the ITU-T G.657.A2 requirements without the complications, costs, or extended time of either the DC or TA designs. Specifically, the TT design comprises an inner cladding that is adjacent to a (Ge-doped) core, which extends to a r_{inner_clad} that is less than ˜4.2*core (r_{inner_clad}/r_{core}<˜4.2). Unlike the DC or TA designs, the delta for the disclosed TT design decreases approximately linearly from r_{core} to r_{inner_clad}. Such a linearly decreasing delta can be fabricated using standard techniques, such as, for example, vapor axial deposition (VAD) or outside vapor deposition (OVD), thereby reducing or eliminating the complications and costs that are associated with current manufacturing processes for DC or TA optical fibers.

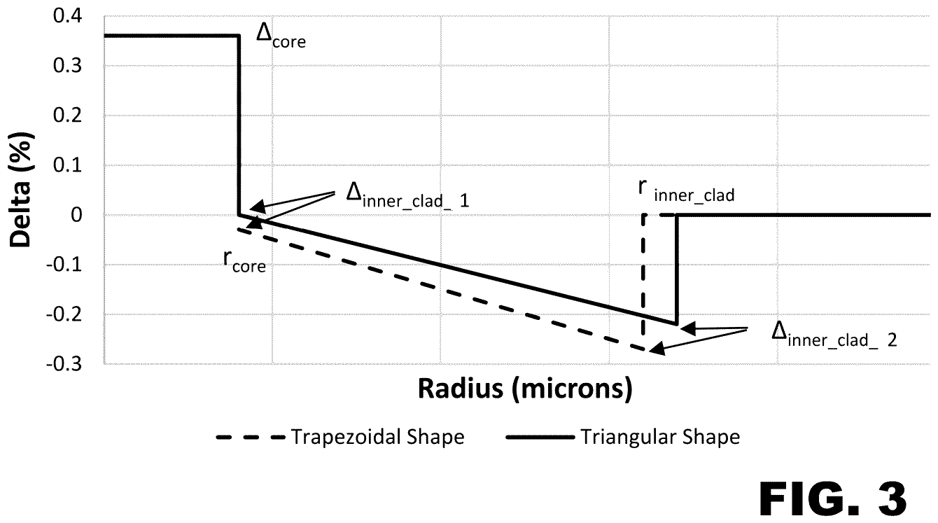

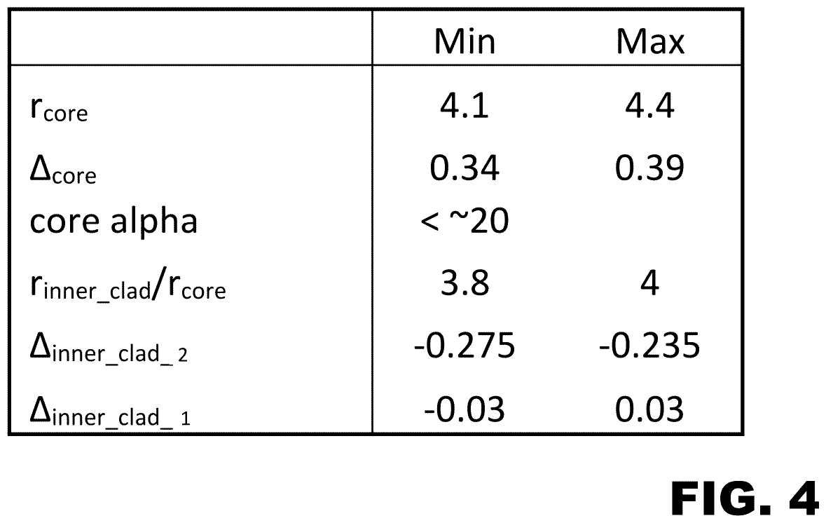

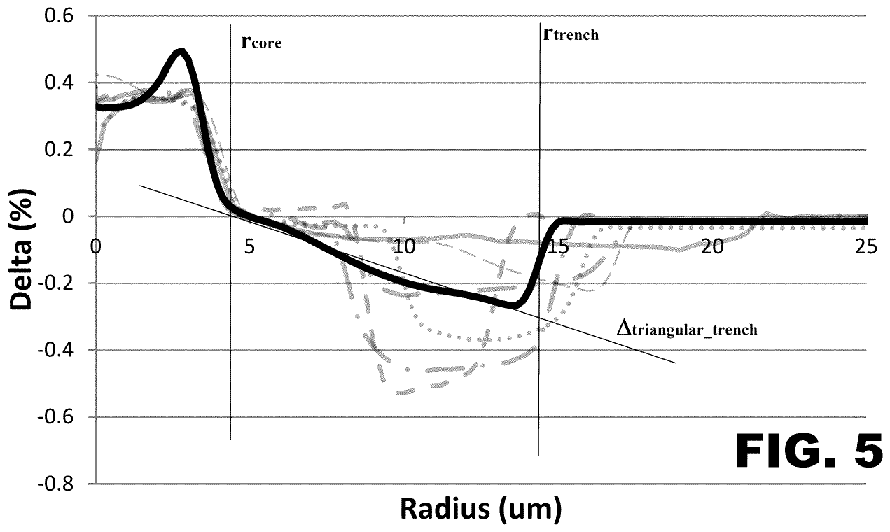

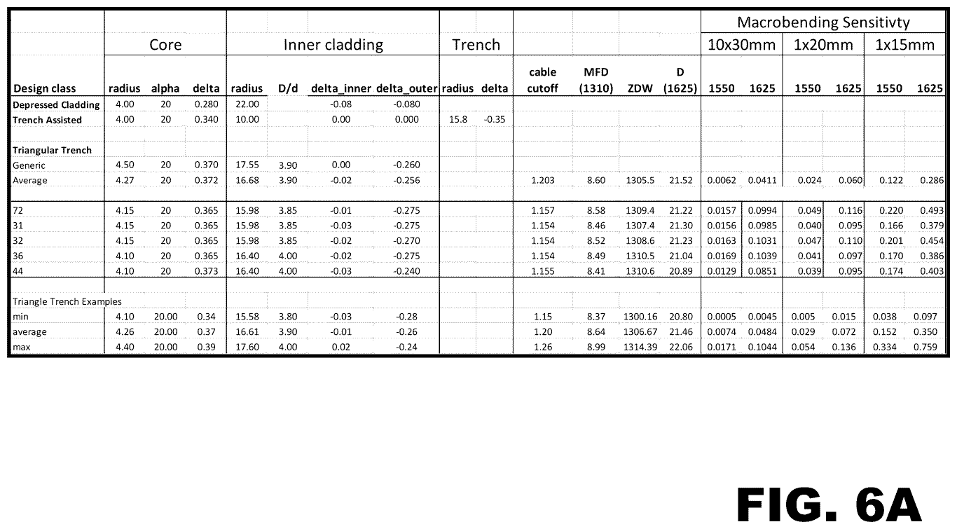

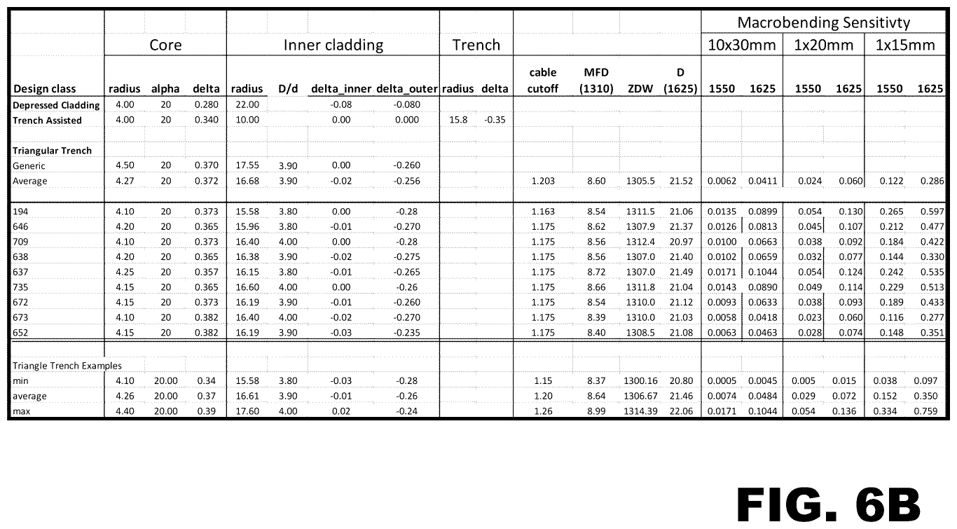

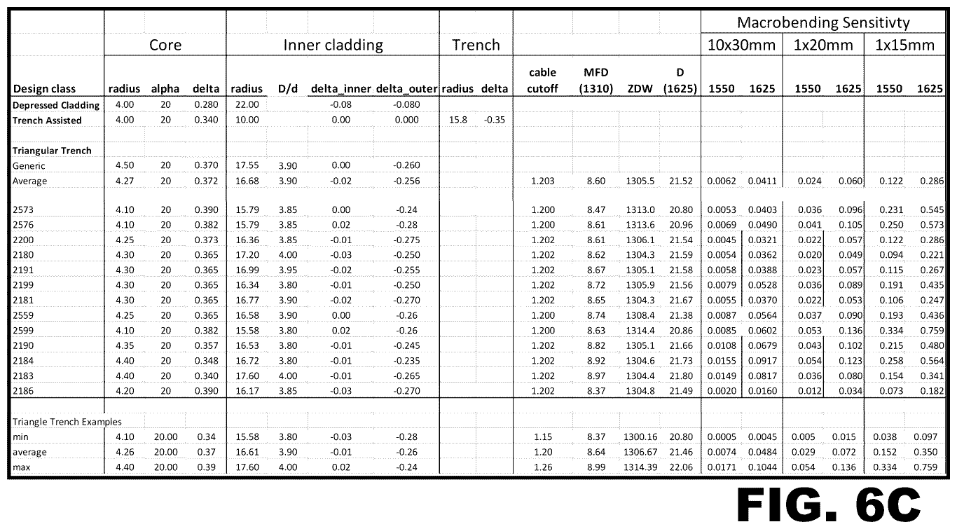

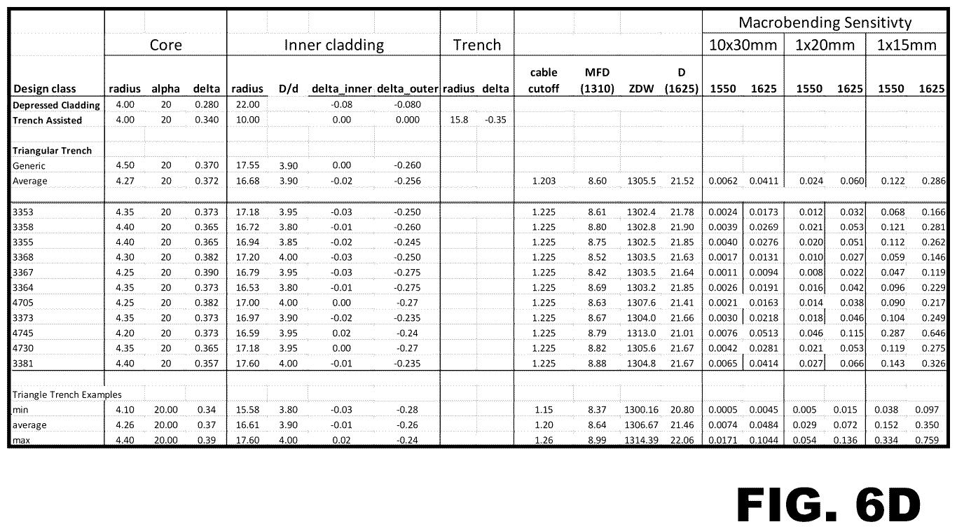

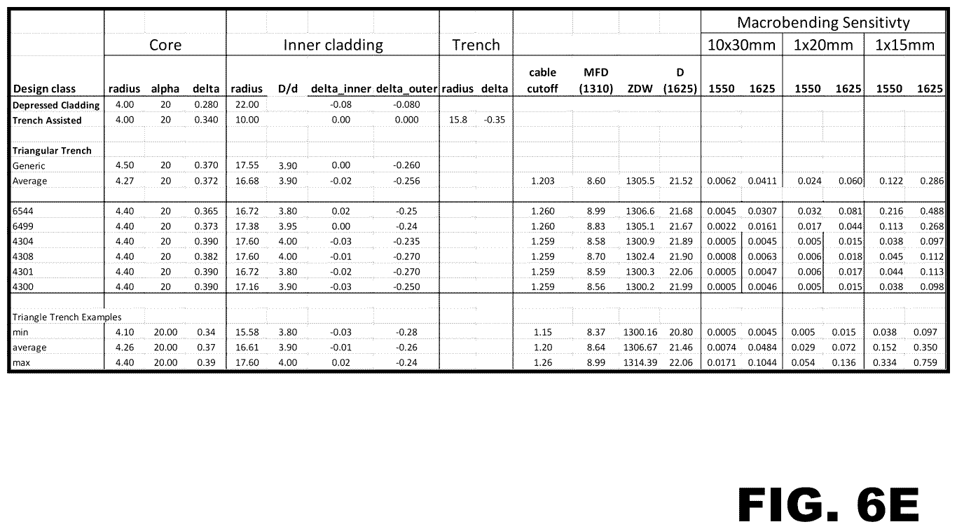

Having provided a broad technical solution to a technical problem, reference is now made in detail to the description of the embodiments as illustrated in the drawings. Specifically, FIGS. 3 and 4 show example index profiles and their physical properties, respectively, for optical fibers having either a triangular trench or a trapezoidal trench; FIG. 5 shows a comparison of the disclosed TT optical fiber with commercially available DC or TA optical fibers; and FIGS. 6A, 6B, 6C, 6D, 6E (collectively designated as FIG. 6) show bend-performance parameters relating to the ITU-T G.657.A2 standards. Although several embodiments are described in connection with these drawings, there is no intent to limit the disclosure to the embodiment or embodiments disclosed herein. On the contrary, the intent is to cover all alternatives, modifications, and equivalents.

Turning now to FIG. 3, both a refractive index profile for a triangular trench design (triangular trench profile (shown as a solid line)) and a refractive index profile for a trapezoidal trench design (trapezoidal trench profile (shown as a broken line)) are shown, both of which have macro-bending losses that comply with the ITU-T G.657.A2 recommendations. Because optical fibers with the trapezoidal trench (where the slope is offset by a non-zero first inner cladding relative refractive index (Δ_{inner_clad_1}<0) is a special case of optical fibers with the triangular trench (where Δ_{inner_clad_1}≅0), or vice versa, both are designated herein as TT optical fibers. For the embodiments of the TT optical fibers that are shown in FIG. 3, a reference relative refractive index (Δ₀) is provided at Δ=0% (for later comparison of Δ values) and an axial center (r₀) is provided at r=0 as a reference point from which all radius (r) measurements are made. It should be appreciated that Δ₀ has a tolerance of ±0.03% (i.e., Δ₀≅0±0.03%).

As shown in the index profiles of FIG. 3, one embodiment of the TT optical fiber comprises a core extending radially from r₀ to a core radius (r_{core}). For some embodiments, the core is doped with Ge and extends to r_{core} that is between approximately four and approximately 4.5 micrometers (˜4.0 μm≤r_{core}≤˜4.5 μm). The core has a core relative refractive index (Δ_{core}), which for some embodiments is between approximately 0.33% and approximately 0.40% (˜0.33±0.03%≤Δ_{core}≤˜0.40±0.03%). For some embodiments, the core is doped with approximately 0.75 weight percent (˜0.75 wt %) to ˜1.5 wt % chlorine (CI), which corresponds generally to Δ_{core} (relative to undoped silica) that is between ˜0.05% and ˜0.1%.

The TT optical fiber further comprises an inner cladding that extends radially from r_{core} to an inner cladding radius (r_{inner_clad}). For the TT optical fiber to have macro-bending losses that comply with ITU-T G.657 requirements, the dimensions of the core and inner cladding should be within the range of ˜3.2≤r_{inner_clad}/r_{core}≤˜4.2. Preferably, r_{inner_clad}/r_{core}≤˜4. The inner cladding comprises a radius-dependent inner cladding relative refractive index (Δ_{inner_clad}(r)), which decreases approximately linearly as a function of radius (r). Specifically, Δ_{inner_clad}(r) decreases from Δ_{inner_clad_1} to a second inner cladding relative refractive index (Δ_{inner_clad_2}). For macro-bending losses that comply with ITU-T G.657 standards, the Δ_{inner_clad_2} should be in the range of:
−0.275±0.03%≤Δ_{inner_clad_2}≤−0.235±0.03%.

Generally, Δ_{inner_clad_1}≤Δ₀, with the triangular trench design being a special case when Δ_{inner_clad_1}=Δ₀. The r-dependent A of the inner cladding follows closely:

Δ_{inner_clad}(r)≅(Δ_{inner_clad_1})+((Δ_{inner_clad_2})*(r−r_{core})/(r_{inner_clad}−r_{core}) [Eq. 1].

The TT optical fiber further comprises an outer cladding that extends radially from r_{inner_clad} to an outer cladding radius (r_{outer_clad}). The outer cladding is either undoped or Cl-doped and has an outer cladding relative refractive index (Δ_{outer_clad}), such that Δ_{inner_clad_2}<Δ_{inner_clad_1}. For typical bend-insensitive fibers that have macro-bending losses that comply with ITU-T G.657 requirements, r_{outer_clad} is not greater than ˜62.5 μm (r_{outer_clad}≤˜62.5±1.0 μm). In other embodiments, r_{outer_clad}≤˜40.0±1.0 μm. For some embodiments, the outer cladding is doped with ˜0.8 wt % to ˜1.1 wt % F, which corresponding to Δ_{outer_clad} (relative to undoped silica) that is somewhere between approximately −0.25% and approximately −0.33%.

The TT optical fiber further comprises a nominal mode-field diameter (MFD) that is between 8.6 μm and 9.2 μm at a center wavelength (λ) of ˜1310 nanometers (nm), with the nominal MFD having a tolerance of approximately ±0.4 μm, a cable cutoff wavelength (λ_{cutoff}) that is less than ˜1260 nm, and macro-bending losses that comply with ITU-T G.657.A2 recommendations.

FIG. 4 shows a table with numerical index-profile parameters that correspond to different embodiments of the index profiles that are shown in FIG. 3. A core alpha of approximately twenty (α≅20) provides a suitable step-index core for the TT optical fiber.

In terms of manufacturing processes, the TT optical fiber is manufactured by first fabricating a soot boule in accordance with known processes, such as VAD or OVD. The soot boule has: (a) a Ge-doped central core with a ˜0.33±0.03%≤Δ_{core}≤˜0.40±0.03%; and (b) an inner cladding that is ˜3.2 to ˜4.2 times the diameter of the central core. To provide the linearly decreasing F-doped trench, a F-containing gas (e.g., SiF₄) is introduced into the furnace atmosphere during the DH step, the sintering step, or an intermediate step between the DH and sintering steps. The radial density variation of F in the soot boule is controlled through careful monitoring of temperature, transverse speed, and concentration of F-containing gas in the furnace atmosphere. Because it is simpler (and more cost effective) to control F in this manner, the triangular or trapezoidal shape is readily obtained without the complexities or costs associated with typical DC or TA optical fiber manufacturing processes. Also, introduction of a small amount of F-containing gas (e.g., carbon tetrafluoride (CF₄)) into the oxidation process during the deposition step is useful in controlling the inner-most cladding shape, particularly for the trapezoidal trench where Δ_{inner_clad_1}<0.

Turning now to FIG. 5, the index profile of the G.657-compliant TT optical fiber (from FIGS. 3 and 4) is compared with index profiles of other commercially available optical fibers. The index profile for the TT optical fiber is shown as a dark solid line, while other commercially available optical fibers are shown in different shades and different types of broken lines. For example, the light-shaded solid line shows the DC optical fiber while the various broken lines show different types of TA optical fibers. It should be noted that, although it may appear that there is overlap in the different index profiles, those having skill in the art will understand that even small variations in index-profile parameters lead to unexpectedly large differences in optical performance. Indeed, even for the same type of optical fiber (e.g., TT optical fiber), small changes sometimes result in performance changes that can bring the optical fiber out of compliance.

Significantly, what FIG. 5 demonstrates is that the DC optical fibers have a shallow Δ_{depressed_clad} (typically above −0.12%) that extends to a relatively large r_{depressed_clad} (beyond 5*r_{core}), while TA optical fibers have a shoulder that is followed by a narrower (r_{trench}<˜10 μm) but much deeper Δ_{trench} (sometimes up to −0.5%). Comparatively, the TT optical fibers occupy an optimum zone (or Goldilocks zone) that is neither too deep nor too shallow and neither too narrow nor too wide.

With this in mind, examples of large performance changes that result from small parameter changes are shown in FIGS. 6A through 6E. Specifically, FIGS. 6A through 6E (collectively, FIG. 6) show bend-performance parameters for several embodiments of TT optical fibers. The tables in FIG. 6 show cable cutoff wavelength (in μm), nominal MFD (in μm) at 1310 nm, zero-dispersion wavelength (ZDW, in nm), and various macro-bending (MB) losses (measured in decibels (dB) for bend diameters of 30 mm, 20 mm, and 15 mm) at wavelengths of 1550 nm and 1625 nm for different core parameters (r, Δ) and inner-cladding parameters (r, Δ). For reference and for purposes of comparison, the values for depressed cladding, trench-assisted, triangular trench (generic), triangular trench (average), and triangular trench examples (min, average, and max) are repeated on each of the tables in FIGS. 6A through 6E.

To demonstrate how small changes in parameter values within the same type of optical fiber (namely, TT optical fiber) can lead to significant changes in performance, compare design class number 4304 (in FIG. 6E) with design class number 637 (in FIG. 6B). A five percent (5%) increase in r_{cladding}/r_{core} from 3.8 to 4.0 and an 11% increase in Δ_{inner_clad_2} from negative 0.265 to negative 0.235 resulted in a nearly thirty-five-fold increase (×35) in MB loss (from 0.0005 dB to 0.0171 dB (for ten (10) turns at a bend diameter of 30 mm at a wavelength of 1550 nm (abbreviated as 10×30 mm 1550 nm))). Another comparison between design class number 4304 (in FIG. 6E) and design class number 2599 (in FIG. 6C) shows a nearly ten-fold increase in MB loss for both 1×15 mm 1550 nm and 1×15 mm 1625 nm.

Because a significant change in performance is sometimes observable for even a small difference in parameter values in the same fiber type (e.g., between TT optical fibers), those having skill in the art will appreciate that larger differences in parameter values between different types of fiber (e.g., DC optical fibers compared to TA optical fibers compared to TT optical fibers) lead to even greater variability and even greater performance differences. Stated succinctly, even subtle differences in parameter values are important because these subtle differences manifest themselves in remarkably different performance characteristics. Consequently, those having ordinary skill in the art fully understand that finding the Goldilocks zone for the optical fiber parameters is neither trivial nor obvious.

As shown above, with reference to FIGS. 1 through 6, deficiencies in DC and TA optical fibers are mitigated by using a TT design that has macro-bending losses that comply with ITU-T G.657.A2 requirements. In other words, the disclosed TT designs have macro-bending losses that comply with the ITU-T G.657.A2 requirements without the complications, costs, or extended time of either the DC or TA designs. Specifically, each of the disclosed TT designs has an inner cladding that is adjacent to a core, with the inner cladding extending to a r_{inner_clad} that is less than ˜4.2*r_{core}. Stated differently, r_{inner_clad}/r_{core}<˜4.2. Unlike the DC or TA designs, the Δ_{inner_clad} for the disclosed TT design decreases approximately linearly from r_{core} to r_{inner_clad}. Such a linearly decreasing delta can be fabricated using standard techniques, such as VAD or OVD, thereby reducing or eliminating the complications and costs that are associated with current manufacturing processes for DC or TA optical fibers.

Any process descriptions or blocks in flow charts should be understood as being executable out of order from that shown or discussed, including substantially concurrently or in reverse order, depending on the functionality involved, as would be understood by those reasonably skilled in the art of the present disclosure.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. An optical fiber comprising:
a reference relative refractive index (Δ₀);
an axial center (r₀);
a core extending radially from r₀ to a core radius (r_{core}), the core comprising a core relative refractive index (Δ_{core});
an inner cladding extending radially from r_{core} to an inner cladding radius (r_{inner_clad}), the inner cladding comprising a r-dependent inner cladding relative refractive index (Δ_{inner_clad}(r)), Δ_{inner_clad}(r) decreasing approximately linearly as a function of r, Δ_{inner_clad}(r) decreasing from a first inner cladding relative refractive index (Δ_{inner_clad_1}) to a second inner cladding relative refractive index (Δ_{inner_clad_2});
an outer cladding extending radially from r_{inner_clad} to an outer cladding radius (r_{outer_clad}), the outer cladding comprising an outer cladding relative refractive index (Δ_{outer_clad});
wherein:
r_{outer_clad} is not greater than ˜62.5 μm (r_{outer_clad}≤˜62.5±1.0 μm);
˜4.0 μm≤r_{core}≤˜4.5 μm;
˜3.2≤r_{inner_clad}/r_{core}≤˜4.2;
Δ₀ is approximately zero percent (Δ₀≅0±0.03%);
˜0.33±0.03%≤Δ_{core}≤˜0.40±0.03%;
Δ_{inner_clad_1}≤Δ₀;
Δ_{inner_clad_2}<Δ_{inner_clad_1};
−0.275±0.03%≤Δ_{inner_clad_2}≤−0.235±0.03%; and
Δ_{inner_clad}(r)≅(Δ_{inner_clad_1})+((Δ_{inner_clad_2})*(r−r_{core})/(r_{inner_clad}−r_{core}));
a nominal mode-field diameter (MFD) between approximately 8.6 μm and approximately 9.2 μm at a center wavelength (λ) of ˜1310 nanometers (nm), the nominal MFD having a tolerance of approximately ±0.4 μm;
a cable cutoff wavelength (λ_{cutoff}) that is less than ˜1260 nm; and
macro-bending losses that comply with ITU-T G.657.A2 recommendations.

2. The optical fiber of claim 1, wherein r_{outer_clad}≤˜40.0±1.0 μm.

3. The optical fiber of claim 1, wherein r_{inner_clad}/r_{core}≤˜4.

4. The optical fiber of claim 1, wherein the outer cladding is undoped or doped with chlorine (Cl).

5. The optical fiber of claim 1, wherein the core is Germanium (Ge) doped.

6. The optical fiber of claim 1, wherein the outer cladding is doped with between approximately 0.8 weight percent (˜0.8 wt %) fluorine (F) and ˜1.1 wt % F.

7. The optical fiber of claim 1, wherein the core is doped with between approximately 0.75 weight percent (˜0.75 wt %) chlorine (Cl) and ˜1.5 wt % Cl.

8. An optical fiber comprising:
a reference relative refractive index (Δ₀);
an axial center (r₀);
a core extending radially from r₀ to a core radius (r_{core}), the core comprising a core relative refractive index (Δ_{core});
an inner cladding extending radially from r_{core} to an inner cladding radius (r_{inner_clad}), the inner cladding comprising a r-dependent inner cladding relative refractive index (Δ_{inner_clad}(r)), Δ_{inner_clad}(r) decreasing approximately linearly as a function of r, Δ_{inner_clad}(r) decreasing from a first inner cladding relative refractive index (Δ_{inner_clad_1}) to a second inner cladding relative refractive index (Δ_{inner_clad_2});
an outer cladding extending radially from r_{inner_clad} to an outer cladding radius (r_{outer_clad}), the outer cladding comprising an outer cladding relative refractive index (Δ_{outer_clad}), Δ_{outer_clad} being approximately equal to Δ₀ (Δ_{outer_clad}≅Δ₀); and
macro-bending losses that comply with ITU-T G.657.A2 recommendations.

9. The optical fiber of claim 8, wherein Δ₀ is approximately equal to zero percent (Δ₀≅0±0.03%).

10. The optical fiber of claim 8, wherein r_{outer_clad} is not greater than ˜62.5 μm (r_{outer_clad}≤˜62.5±1.0 μm).

11. The optical fiber of claim 10, wherein r_{outer_clad}≤˜40.0±1.0 μm.

12. The optical fiber of claim 8, wherein r_{core} is not less than approximately 4.0 micrometers and not greater than approximately 4.5 micrometers (˜4.0 μm≤r_{core}≤˜4.5 μm).

13. The optical fiber of claim 8, wherein r_{inner_clad}/r_{core} is between approximately 3.2 and approximately 4.2 (˜3.2≤r_{inner_clad}/r_{core}≤˜4.2).

14. The optical fiber of claim 13, wherein r_{inner_clad}/r_{core}≤˜4.

15. The optical fiber of claim 8, wherein Δ_{core} is between approximately 0.33 percent and approximately 0.40 percent (˜0.33±0.03%≤r_{core}≤˜0.40±0.03%).

16. The optical fiber of claim 8, wherein Δ_{inner_clad_1} is not greater than 40 (Δ_{inner_clad_1}≤ Δ₀), and wherein Δ_{inner_clad_2} is less than Δ_{inner_clad_1} (Δ_{inner_clad_2}<Δ_{inner_clad_1}).

17. The optical fiber of claim 8, wherein the outer cladding is doped with between approximately 0.8 weight percent (˜0.8 wt %) fluorine (F) and ˜1.1 wt % F, and wherein the core is doped with between ˜0.75 wt % chlorine (Cl) and ˜1.5 wt % Cl.

18. The optical fiber of claim 8, wherein Δ_{inner_clad_2} is between approximately −0.235 percent and approximately −0.275 percent (−0.275±0.03%≤Δ_{inner_clad_2}≤−0.235±0.03%).

19. The optical fiber of claim 8, wherein:
Δ_{inner_clad}(r)≅(Δ_{inner_clad_1})+((Δ_{inner_clad_2})*(r−r_{core})/(r_{inner_clad}−r_{core})).

20. The optical fiber of claim 8, further comprising:
a nominal mode-field diameter (MFD) between approximately 8.6 μm and approximately 9.2 μm at a center wavelength (λ) of approximately 1310 nanometers (˜1310 nm), the nominal MFD having a tolerance of approximately ±0.4 μm; and
a cable cutoff wavelength (λ_{cutoff}) that is less than ˜1260 nm.
